(19) United States
(12) Patent Application Publication
(10) Pub. No.: US 2026/0264333 A1
(43) Pub. Date: Sep. 10, 2026

(54) METHOD AND SYSTEM FOR LARGE 3D OBJECT PRINTING IN DUSTY ENVIRONMENT

(71) Applicant: INTERNATIONAL BUSINESS MACHINES CORPORATION, Armonk, NY (US)

(72) Inventors: Carolina Garcia Delgado, Zapopan (MX); Sarbajit Kumar Rakshit, Kolkata (IN); Jennifer M. Hatfield, Portland, OR (US); Aaron Keith Baughman, Cary, NC (US)

(21) Appl. No.: 19/075,186

(22) Filed: Mar. 10, 2025

(51) Int. Cl. B29C 64/35; B29C 64/386; B33Y 40/00; B33Y 50/00

(52) U.S. Cl. CPC B29C 64/35; B29C 64/386; B33Y 40/00; B33Y 50/00

(57) ABSTRACT

A device for protecting a 3D print from environmental dust particles, comprising a body and a duster. The body configured to couple to a nozzle of a 3D printer. The body includes a first chamber and a second chamber. The duster is disposed within the first chamber and is configured to remove dust particles disposed on a solid surface. The 3D printer has a moving direction and is configured to deposit soft material from the nozzle while translating the nozzle along the moving direction. The soft material solidifies after deposition. When the body is coupled to the nozzle, the first chamber extends in the moving direction from the nozzle, extending over the solid surface and the second chamber extends opposite the moving direction from the nozzle, extending over the soft material being deposited and solidified.

### BACKGROUND

Embodiments of the present disclosure relate to methods and systems for 3D object printing in dusty environments, and more specifically to systems configured to attach to the nozzle of 3D printers.

### BRIEF SUMMARY

According to embodiments of the present disclosure, a device for protecting a 3D print from environmental dust particles is provided. The device comprises a body and a duster. The body is configured to couple to a nozzle of a 3D printer. The body includes a first chamber and a second chamber. The duster is disposed within the first chamber and is configured to remove dust particles disposed on a solid surface. The 3D printer has a moving direction and is configured to deposit soft material from the nozzle while translating the nozzle along the moving direction. The soft material solidifies after deposition. When the body is coupled to the nozzle, the first chamber extends in the moving direction from the nozzle, extending over the solid surface and the second chamber extends opposite the moving direction from the nozzle, extending over the soft material being deposited and solidified.

In some embodiments, the solid surface is a solidified surface of 3D printed material.

In some embodiments, the solid surface is a printing bed.

In some embodiments, the body includes a cutout configured to encircle a nozzle of the nozzle assembly.

In some embodiments, the device further comprises a nozzle protector extending through the cutout and configured to partially separate the nozzle from the body.

In some embodiments, the device further comprises a dust sensor configured to monitor a concentration of the environmental dust particles.

In some embodiments, the duster comprises a plurality of channels each configured to direct a fluid over the solid surface.

In some embodiments, each of the plurality of channels is pivotably coupled to the duster.

In some embodiments, the plurality of channels comprises a first channel configured to direct water over the solid surface and a second channel configured to direct air over the solid surface.

In some embodiments, the duster is configured to detect a presence of dust particles on the solid surface, and to selectively activate one or more channels of the plurality of channels upon detection.

In some embodiments, the duster is configured to selectively activate the one or more channels in a sequential order.

In some embodiments, the duster is configured to determine a type of dust particles on the solid surface, and to selectively activate one or more channels of the plurality of channels depending on the type of dust particles detected.

In some embodiments, the duster is configured to selectively activate the one or more channels in a sequential order.

In some embodiments, the duster comprises a wiper configured to wipe the solid surface.

In some embodiments, the wiper is pivotably coupled to the duster.

In some embodiments, the first chamber and the second chamber are separable.

In some embodiments, the first chamber comprises a first cutout and the second chamber comprises a second cutout, the first cutout and second cutout configured to form a continuous edge around the nozzle when the chamber is coupled to the nozzle.

In some embodiments, the device further comprises a camera coupled to the nozzle. The camera can be configured to detect solidification of the soft material.

In some embodiments, the first chamber and the second chamber each include three sidewalls, forming a U-shaped channel with a major axis of the U-shaped channel being parallel to the moving direction.

In some embodiments, the sidewalls of the first chamber are coplanar with the sidewalls of the second chamber.

### BRIEF DESCRIPTION OF THE SEVERAL VIEWS OF THE DRAWINGS

FIG. 1 is a schematic illustrating a 3D printer nozzle assembly, in accordance with one or more embodiments of this disclosure.

FIG. 2A is a schematic illustrating a device for protecting a 3D print from environmental dust particles, in accordance with one or more embodiments of this disclosure.

FIG. 2B is a schematic illustrating a cleaning module (e.g., a duster) of a device for protecting a 3D print from environmental dust particles, in accordance with one or more embodiments of this disclosure.

FIG. 2C is a diagram illustrating cleaning sequences of the cleaning module, in accordance with one or more embodiments of this disclosure.

FIG. 2D is a schematic illustrating an exemplary motion of a channel of a cleaning module, in accordance with one or more embodiments of this disclosure.

FIG. 3 is a schematic illustrating a device for protecting a 3D print from environmental dust particles, in accordance with one or more embodiments of this disclosure.

### DETAILED DESCRIPTION

Reference has been made in detail herein to the exemplary embodiments of the present disclosure, examples of which are illustrated in the accompanying drawings. The systems, devices, and methods disclosed herein are described in detail by way of examples, and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

3D printing, also known as additive manufacturing, is a process used to create three-dimensional solid objects from a digital file. This process involves the successive deposition of material layers, each corresponding to a thin, sliced cross-section of the object. Unlike substrative manufacturing methods, which involve removing material (e.g., with a milling machine), 3D printing builds objects layer by layer, allowing for the creation of complex geometries with reduced material waste. 3D printing can also be used to repairing existing structures. 3D printing systems can utilize robotic technologies, enabling autonomous mobility and collaborative printing. These robotic systems can work in unison as a swarm, performing printing tasks in a synchronized manner, which increases the efficiency and scalability for both manufacturing and repair applications.

One application of large-scale 3D printing technology is in the construction of residential buildings. The printing of houses can offer the potential to significantly enhance the efficiency and cost-effectiveness of the construction process, while reducing material waste and construction time. Several companies and organizations are currently developing and implementing 3D printing technology for house construction. Houses can be printed in sections at a factory and then assembled on-site in a matter of days, allowing for intricate designs and complex geometries that traditional construction methods may be unable to achieve. Alternatively, houses can be printed directly at the construction site using a mobile 3D printer which prints the house layer by layer.

Dusty environments present significant challenges to the 3D printing process because the presence of dust particles can interfere with the printer's functionality and degrade the quality of the printed object. Specifically, dust particles may obstruct (e.g., clog) the nozzle of the 3D printer, hindering the extrusion of the printing material and resulting in incomplete or distorted prints. Additionally, dust particles can settle on the printing bed or the object being printed, disrupting the printer's ability to accurately deposit the material, leading to misalignment of layers or overall distortion of the printed object. Furthermore, dust particles can compromise the adhesion of the printing material to the printing bed or the object itself, resulting in poor-quality prints or causing prints to detach from the bed during the printing process. The accumulation of dust on the printer's internal components, such as motors, belts, and other parts, can also lead to malfunctions or accelerated wear, potentially reducing the longevity and reliability of the 3D printer.

For small-scale 3D printing, various methods are available to maintain a dust-free environment, such as regularly cleaning the printer and its components, using a dust cover to protect the printer when not in use, maintain the printing area well-ventilated to minimize dust accumulation, and utilizing filters (e.g., a HEPA filter) to capture and remove dust particles from the air. However, in large-scale 3D printing applications in environments with significant dust exposure (e.g., colonization of the moon, desert environments, polluted environments, factory environments, etc.), the entire printing environment may be affected by dust. In such settings, dust can mix with the printed object, potentially comprising the quality and integrity of the final product. Hence, there is a need for an apparatus, system, and method that allows for 3D printing to be effectively conducted in dusty environments without impacting the quality of the 3D object.

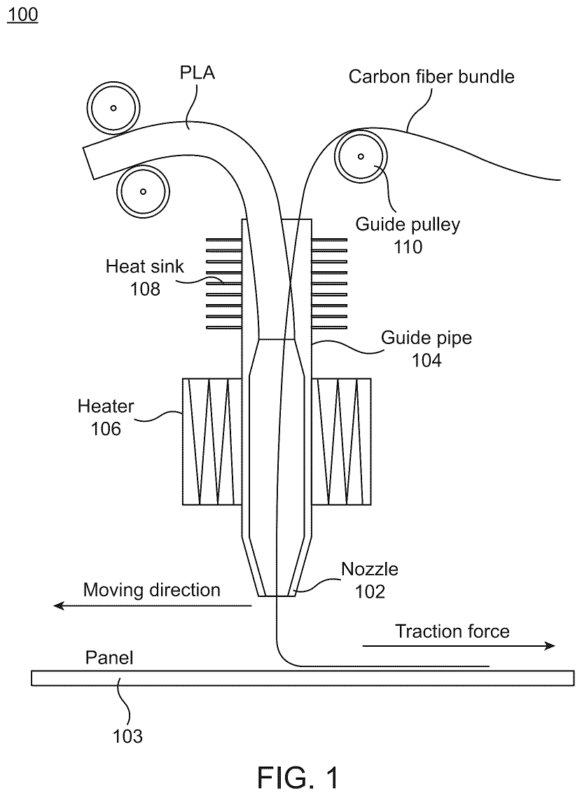

FIG. 1 is a schematic illustrating a 3D printer nozzle assembly. The nozzle 102, through which the extruded material (e.g., polylactic acid (PLA)) is deposited onto the print bed 103, is positioned at the end of the guide pipe 104. The material is heated by a heater 106 to a specific temperature to melt it before being extruded through the nozzle. The heater 106 surrounds the nozzle 102 and/or part of the guide pipe 104 to ensure the material is fully melted for consistent extrusion. A heat sink 108 is positioned upstream from the nozzle 102 to prevent the filament from premature melting as it travels through the guide pipe. A guide pulley 110 is configured to manage the movement of the filament (e.g., carbon fiber bundle and/or PLA) as it is pulled through the guide pipe 104 and then extruded out of the nozzle 102. In a 3D printing system capable of printing composite materials, different filaments can be routed through the same guide pipe. For example, a carbon fiber bundle made be fed through a separate guide pulley from the PLA and into the same guide pipe. In operation, material is extruded out the nozzle as the print bed 103 and/or the nozzle assembly are moved relative to each other.

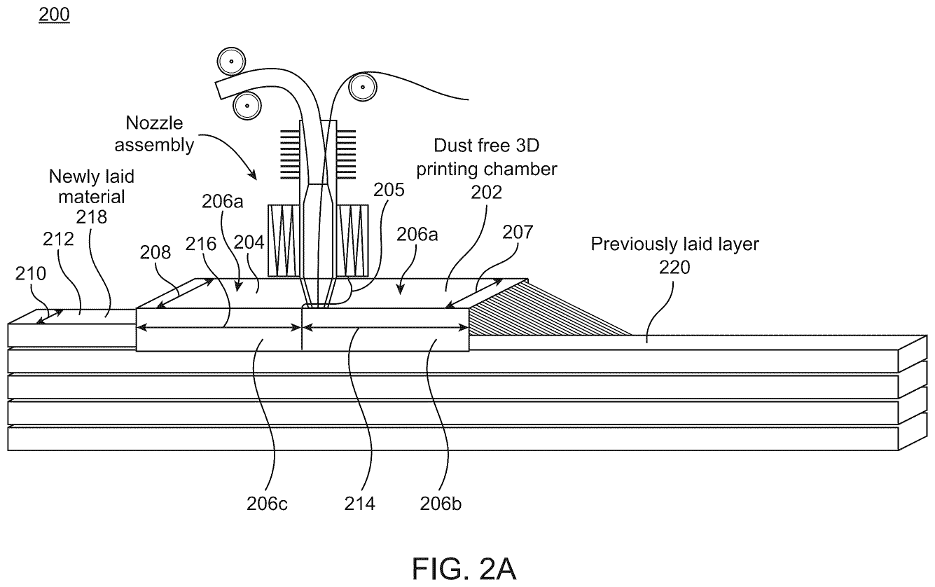

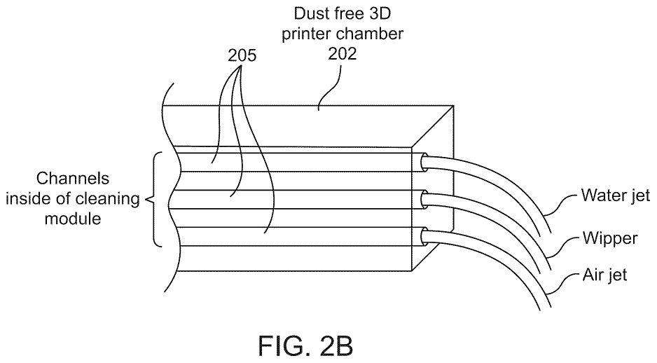

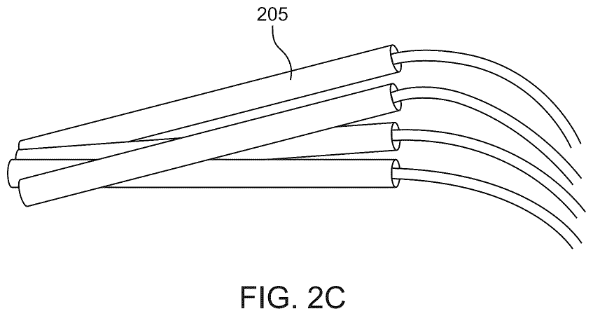

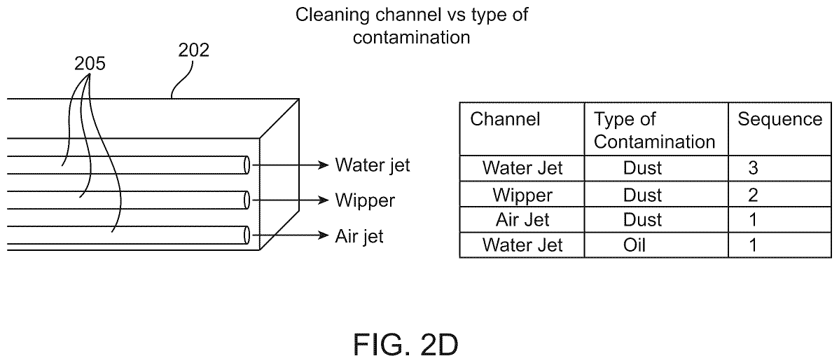

FIG. 2A is a schematic illustrating a device for protecting a 3D print from environmental dust particles. As shown in FIG. 2A, the device 200 includes a printing chamber 202 and a protection chamber 204 that are removably coupled to the nozzle assembly of the 3D printer. In some embodiments, the printing chamber 202 and the protection chamber 204 form a single unit. In some embodiments, the printing chamber 202 and the protection chamber 204 are separate elements. For example, the printing chamber 202 and the protection chamber 204 can be coupled to each other using a first coupling mechanism and then coupled to the nozzle via a second coupling mechanism. In another example, the printing chamber 202 and the protection chamber 204 can each be coupled to the nozzle directly via a coupling mechanism. The coupling mechanism can include a fastening mechanism (e.g., screw, nut, washer, bolt), opposing magnetic contacts, a snap-fit joints, a latch, mechanical clamps, and/or interlocking joints.

The printing chamber 202 and the protection chamber 204 can each include a chamber structure having an open side (open bottom) extending into an interior volume of the structure. In some embodiments, the structures of the printing chamber 202 and the protection chamber 204 each include three sidewalls, forming a U-shaped channel. In some embodiments, the structures of the printing chamber 202 and the protection chamber 204 are in the form of a curved shell (e.g., semi-cylindrical channel). The structures of the printing chamber 202 and the protection chamber 204 can each include a cutout 205 (e.g., circular cutout) that follows the contour of the nozzle, allowing the printing chamber and protection module to fit around the nozzle. For example, the cutout 205 can be positioned on the upper wall 206a of the printing chamber 202 and the protection chamber 204. In some embodiments, gasket (e.g., heat resistant gasket) can be disposed between the exterior surface of the nozzle and the edge of the cutout 205 (of the printing chamber and the protection module), thereby forming a seal around the nozzle. The width 207 of the printing chamber 202 and the width 208 of the protection chamber 204 can be about the width 210 of the printed layer 212 or greater. The length 214 of the printing chamber 202 and the length 216 of the protection chamber 204 may be different or about the same. For example, the protection chamber 204 may be longer than the printing chamber 202. When the printing chamber 202 and the protection chamber 204 are attached to the nozzle, their sidewalls are about coplanar (e.g., sidewall 206b about coplanar with sidewall 206c).

The protection chamber 204 is configured to protect the newly laid material 218 from surrounding dust particles (e.g., dust) during the printing process. Environmental dust particles, as referred herein, can include dirt, pollen, hair, fibers, plastic fragments, etc. Environmental dust particles can also contain a liquid substance (e.g., oil, grease, sticky substance, etc.). The protection chamber 204 is configured to cover the surface area of the newly laid material, preventing dust particles from contaminating the soft material during the solidification phase. In some embodiments, the speed of the nozzle assembly is reduced (e.g., slowed down or paused) until the newly laid material has solidified. Once the solidification is complete, the speed of the nozzle can be gradually increased to resume the printing process. In this way, dust particles cannot mix and bond with the newly laid material during solidification. Dust particles may settle on the solidified surfaces as the nozzle assembly, protection chamber 204, and printing chamber 202 move together.

Depending on the type of material laid, the protection chamber 204 may include additional components configured to accelerate the solidification of the newly laid material. The protection chamber 204 may include attachment points (e.g., mounts), grooves, and/or openings (e.g., slots, cutouts) configured to receive and secure additional components. In some embodiments, the protection chamber 204 includes a heat transfer system (e.g., a cooling system and/or a heating system). In some embodiments, heating and/or cooling is applied to accelerate the solidification of the newly laid material. In some embodiments, the protection chamber 204 includes an ultraviolet (UV) light source. In some embodiments, the protection chamber 204 includes one or more fans. For example, one or more fans may be mounted on an interior surface of the protection module. Fan(s) may be oriented to direct airflow across the material from the interior volume of the protection module towards the exterior environment. In some embodiments, the protection chamber 204 includes vents with filters (e.g., HEPA filter, electrostatic filter), which allow for passive airflow through the protection module. The protection chamber 204 can be positioned such that it extends (longitudinally) over the newly laid material 218. The printing chamber 202 can be positioned such that it extends (longitudinally) over the previously laid material 220.

The printing chamber 202 is configured to remove dust particles from the previously laid layer 220 before the nozzle assembly extrudes new material over it. In this way, the previously laid layer 220 is dust-free when new material is deposited. The printing chamber 202 can include one or more means of dust removal. For example, the printing chamber 202 can include a dust-cleaning module (e.g., duster) that employs one or more methods (e.g., individually in a sequence or multiple simultaneously) to clean the dust from the previously laid layer. These methods may include liquid jet-based cleaning, electrostatic dust cleaning, gas blow-based dust cleaning, brush-based cleaning, wiper-based cleaning, vacuum-based cleaning, and/or laser-based cleaning. In some embodiments, the dust cleaning module is capable of identifying the type of dust particles (e.g., loose dust, oil substance, etc.) and/or measuring the amount (e.g., thickness, surface area) of dust disposed on the previously laid layer and/or the amount (e.g., concentration) of dust suspended in the air within the printing chamber 202. For example, the dust cleaning module can include light scattering sensors, infrared sensors, and/or electrostatic sensors. In some embodiments, depending on the type of dust and/or amount of the dust on the previously laid layer, the cleaning module can automatically select an appropriate combination of cleaning methods. The cleaning module can automatically select the duration of the cleaning method(s) and other configuration settings, such as fluid flow rate, pressure levels, intensity of the electrostatic fields, and laser power. In some aspects, the optimization of the cleaning methods by the cleaning module can help reduce costs and conserve energy and other resources.

Referring to FIG. 2B, the cleaning module (e.g., duster) can include multiple channels 205 (e.g., cylindrical channels, rectangular channels) configured to direct a fluid (e.g., air, water, wiper fluid) over a solid surface (e.g., printing bed, solidified 3D printing material). The multiple channels may be coupled to pumps, valves, nozzles, and/or fluid reservoirs (e.g., containers holding fluid). Fluid may be directed over surfaces covered by the printing chamber 202 or surfaces outside of the chamber. The angular orientation of the channels 205 with respect to a horizontal may be adjusted (automatically or manually) in order to more effectively distribute fluid over the surface area. FIG. 2D is a diagram illustrating cleaning sequences of the cleaning module. For example, if dust is detected on the previously laid layer, the air jet can be activated first, followed by spraying of a wiper fluid, and a water jet. The cleaning module may include a brush, or a wiper configured to clear dust or contamination from a surface (e.g., the previously laid layer). The wipe or brush may be pivotably coupled to the cleaning module, allowing it to move (e.g., rotate) in a controlled manner. The brush or wiper can be at least partially absorbent so that they absorb the fluid disposed on the surface. In some embodiments, an air jet is used to dry the solid surface after applying other cleaning methods (e.g., methods involving liquids).

In some embodiments, a swarm robotic system is disposed on the previously laid layer and employs one or more methods (e.g., individually in a sequence or multiple simultaneously) to clean the dust from the previously laid layer. The swarm robotic system may apply cleaning methods such as brushing, vacuuming, liquid jets, and/or air jets. The swarm robotic system can include sensors configured to detect dust type and quantity.

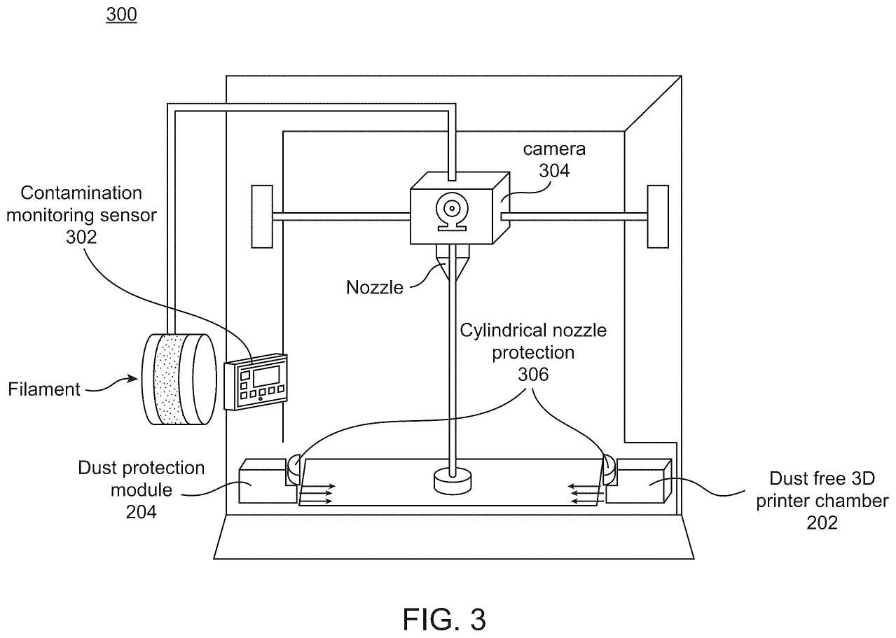

FIG. 3 is a schematic illustrating a device for protecting a 3D print from environmental dust particles. As shown in FIG. 3, the device 300 can include a contamination monitoring sensor 302 (e.g., particle counter) configured to detect dust and contamination inside of the system (e.g., within the 3D printer nozzle assembly, within the printing chamber 202, and/or within the protection chamber 204). A camera 304 can be positioned proximal to the nozzle, with its field of view imaging the nozzle, the newly laid layer, and the previously laid layer. In some embodiments, the camera 304 includes multiple cameras. In some embodiments, the camera is the camera of the 3D printer. In some embodiments, a camera is mounted to the nozzle assembly. The camera may be used to verify that the newly laid layer is solidified. The change in the material (e.g., from soft, semi-solid to solidified material) can be identified using a software (e.g., Maximo Visual Inspection) that analyzes images and/or video captured by the camera.

The device can include a flow sensor configured to monitor the flow rate of the extruded material from the nozzle. In some embodiments, the flow sensor is communicatively coupled to an indicator (e.g., audible indicator, visible indicator) that provides a status (e.g., alert) on the flow rate of the extruded material. In this way, a user can be alerted when the nozzle is blocked or clogged.

In some embodiments, the levels of dust and contamination (e.g., concentration of in the air, thickness on surfaces) are determined (e.g., estimated) based on factors such as location, weather, predicted weather conditions, and/or any historical knowledge/data of the environment. The assessment of the dust and contamination may be performed prior to 3D printing. In some embodiments, if dust and contamination exceed a certain threshold, the printing chamber 202 and the protection chamber 204 automatically assemble. For example, the printing chamber 202 and the protection chamber 204 may be hingedly attached to the nozzle so that when dust and contamination levels are below a certain threshold (e.g., none detectable), the chamber and module are in an open/unassembled configuration. When dust and contamination exceed the threshold, the chamber and module are in a closed/assembled configuration (e.g., shown in FIG. 2). In some embodiments, if dust and contamination exceed a certain threshold, an indicator provides a status indicating the presence of dust and contamination. In this way, a user may manually assemble the device (e.g., couple the printing chamber 202 and the protection chamber 204 to the nozzle).

In some embodiments, the device includes a nozzle protector 306 configured to protect the nozzle from dust and contamination. The nozzle protector 306 may have a cylindrical shell structure that encircles the nozzle. In some embodiments, the nozzle protector 306 is a single unit. In some embodiments, the nozzle protector 306 includes a plurality of elements (e.g., two elements). For example, the nozzle protector 306 may include two semi-cylindrical shell structures configured to coupled with each other.

For any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

As used herein, the term “about” means a range of values inclusive of the specified value that a person of ordinally skill in the art would reasonably consider to be comparable to the specified value. In some embodiments, “about” means within a standard deviation using measurements generally accepted by a person of ordinary skill in the art. In some embodiments, “about” means ranging up to ±10% of the value. In some embodiments, “about” means ranging up to ±5% of the value. In some embodiments, “about” means the specified value.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device for protecting a 3D print from environmental dust particles, the device comprising:
a body configured to couple to a nozzle of a 3D printer, the body comprising a first chamber and a second chamber; and
a duster disposed within the first chamber and configured to remove dust particles disposed on a solid surface, wherein
the 3D printer has a moving direction and is configured to deposit soft material from the nozzle while translating the nozzle along the moving direction, the soft material solidifying after deposition, and
when the body is coupled to the nozzle, the first chamber extends in the moving direction from the nozzle, extending over the solid surface and the second chamber extends opposite the moving direction from the nozzle, extending over the soft material being deposited and solidified.

2. The device of claim 1, wherein the solid surface is a solidified surface of 3D printed material.

3. The device of claim 1, wherein the solid surface is a printing bed.

4. The device of claim 1, wherein the body includes a cutout configured to encircle the nozzle.

5. The device of claim 4, further comprising a nozzle protector extending through the cutout and configured to partially separate the nozzle from the body.

6. The device of claim 1, further comprising a dust sensor configured to monitor a concentration of the environmental dust particles.

7. The device of claim 1, wherein the duster comprises a plurality of channels each configured to direct a fluid over the solid surface.

8. The device of claim 7, wherein each of the plurality of channels is pivotably coupled to the duster.

9. The device of claim 7, wherein the plurality of channels comprises a first channel configured to direct water over the solid surface and a second channel configured to direct air over the solid surface.

10. The device of claim 7, wherein the duster is configured to detect a presence of dust particles on the solid surface, and to selectively activate one or more channels of the plurality of channels upon detection.

11. The device of claim 10, wherein the duster is configured to selectively activate the one or more channels in a sequential order.

12. The device of claim 7, wherein the duster is configured to determine a type of dust particles on the solid surface, and to selectively activate one or more channels of the plurality of channels depending on the type of dust particles detected.

13. The device of claim 12, wherein the duster is configured to selectively activate the one or more channels in a sequential order.

14. The device of claim 1, wherein the duster comprises a wiper configured to wipe the solid surface.

15. The device of claim 14, wherein the wiper is pivotably coupled to the duster.

16. The device of claim 1, wherein the first chamber and the second chamber are separable.

17. The device of claim 16, wherein the first chamber comprises a first cutout and the second chamber comprises a second cutout, the first cutout and second cutout configured to form a continuous edge around the nozzle when the body is coupled to the nozzle.

18. The device of claim 1, further comprising a camera coupled to the nozzle, the camera configured to detect solidification of the soft material.

19. The device of claim 1, wherein the first chamber and the second chamber each include three sidewalls, forming a U-shaped channel, a major axis of the U-shaped channel being parallel to the moving direction.

20. The device of claim 19, wherein the sidewalls of the first chamber are coplanar with the sidewalls of the second chamber.
